(19) United States
(12) Patent Application Publication
(10) Pub. No.: US 2012/0262305 A1
(43) Pub. Date: Oct. 18, 2012

(54) Identifying Parking Spots

(75) Inventors: Jason Woodard, Astoria, NY (US); Joseph Catalano, Farmingdale, NY (US)

(73) Assignee: Google Inc.

(21) Appl. No.: 13/250,734

(22) Filed: Sep. 30, 2011

Related U.S. Application Data
(63) Continuation of application No. 13/086,848, filed on Apr. 14, 2011.

(51) Int. Cl. G08G 1/14

(52) U.S. Cl. 340/932.2

(57) ABSTRACT

A method includes receiving a report of an open parking spot and parking data that indicates a geographic location of the open parking spot, the report being generated based at least in part on determined movement of the mobile computing device; starting a timer relating to the open parking spot; receiving one or more requests for reporting of open parking spots; determining whether a time relating to the open parking spot has expired; and based on determining that a time relating to the open parking spot has not expired, providing in response to the one or more requests, data for generating a graphical indication of the open parking spot on a map of an area around the open parking spot for display on the one or more computing devices.

### CROSS-REFERENCE TO RELATED APPLICATIONS

This application is a continuation of U.S. patent application Ser. No. 13/086,848, filed Apr. 14, 2011, which is incorporated herein in its entirety.

This document relates to actions that may be taken by or with a mobile computing device such as a smartphone, including actions of identifying parking spots.

### TECHNICAL FIELD

### Background

Mobile communication devices allow users to make telephone calls, receive email, browse the World Wide Web, listen to audio content, and view video content. Such devices have gotten more powerful over the years, to the point where they can now execute various custom, downloaded applications for a variety of needs. Many of the applications are very sophisticated and may access server-based data automatically while they are running so as to provide a rich user experience.

The number and type of sensors on smartphones has so proliferated in recent years. Many such devices now have electronic compasses, accelerometers, GPS units, cameras, proximity sensors, and other such sensors. These sensors can be used in a variety of manners, such as to determine a user's location with a GPS unit, and the user's orientation with a compass unit. Other applications can provide basic turn-by-turn navigation in response to a user's provision of an address to a device. Also, dedicated navigation units permit a user to type in a destination address and to have turn-by-turn directions provided between the user's current location and the destination address.

### SUMMARY

This document describes systems and techniques that may be used to notify users of computing devices, such as smartphones, of the presence and location of parking spots that are likely to be open. For example, such systems may take reports form mobile devices that are in vehicles that are vacating parking spaces, and may treat the vacated parking spaces as being open for a period of time. Other users who request the status of parking spaces in a particular area may then see such statuses, including on a graphical user interface on which open parking spots are overlaid on a navigational map of an area around a requesting user. The statuses of the parking spots may change as more time elapses after they were reporting as having been vacated, such as by being displayed as a green dot for 5 minutes after the spot is vacated, a yellow dot for 5 to 10 minutes, and a red dot for the next 10 minutes. The speed with which the status changes after the spot is vacated may also be a function of a speed with which parking spots are re-filled in a particular area (as determine by a system observing refill rates over time), so that, for example, the statuses may change faster in an urban core than in a suburb.

The vacating and filling of parking spots may be identified in various manners. For example, users may launch a parking application (which may be part of, or a displayed layer on, a maps or navigation application) and may manually report when they enter or leave a parking spot, and GPS capabilities on their device may report the location of the parking spot. Alternatively, a device may report automatically when it shifts from moving at a high speed (e.g., over 20 miles per hour) to being stationary, and then to a walking speed. The reporting would be triggered by an opposite pattern for the reporting of the vacating of a parking spot. Such a report may be received by a system, which may then compare it to prior reports and map data to confirm that the change in speed of the device corresponds to a relevant parking spot (e.g., to ensure that it is an area accessible to cars and that it is not part of a private parking garage).

In one implementation, a computer-implemented method for tracking parking spot availability is disclosed. The method comprises receiving, at a computer server system from a mobile computing device that is remote from the computer server system, a report of an open parking spot and parking data that indicates a geographic location of the open parking spot, the report being generated based at least in part on determined movement of the mobile computing device; starting a timer relating to the open parking spot; receiving, at the computer server system and from one or more mobile computing devices, one or more requests for reporting of open parking spots; determining whether a time relating to the open parking spot has expired; and based on determining that a time relating to the open parking spot has not expired, providing in response to the one or more requests, data for generating a graphical indication of the open parking spot on a map of an area around the open parking spot for display on the one or more computing devices. The movement can comprise a vibration of the mobile computing device, or a determined velocity of the mobile computing device. Also, the report can be generated in response to the velocity of the mobile computing device increasing above a threshold value for a predetermined length of time.

In certain aspects, the computer server system does not maintain an association between the mobile computing device and parking data received from the mobile computing device. The method can also include deleting one or more records that identify an association between the mobile computing device and parking data received from the mobile computing device. The method can additionally comprise determining whether the first open parking spot is public parking spot. In addition, the method can include receiving confirmation data from the mobile computing device, the confirmation data representing a user command to initiate or prevent the generation of the report. Moreover, the method can further comprise receiving, from one or more mobile computing devices, additional requests for reporting of open parking spots in a given area; identifying respective times at which the requests were received; and calculating a historical demand for parking in the given area for one or more periods of time based at least in part on the requests and the identified times.

In yet other aspects, the method also includes determining a likelihood that one or more parking spots are open in the given area during the one or more periods of time based at least in part on the historical demand. The method can also include filtering parking spots based at least in part on respective prices of the parking spots. Moreover, the method may comprise providing turn-by-turn navigation directions to the first parking spot, and more particularly, providing turn-by-turn navigation data for an area having one or more parking spots that correspond to one or more preferences associated with the one or more computing devices. The one or more preferences can also comprise one or more of parking price, parking availability, and limits on a length of parking time, and the method may also include providing rewards to accounts that are associated with mobile computing devices that access one or more services provided by the computer server system. Providing such rewards to the accounts can comprise awarding points to an account associated with a mobile computing device based on the provision of a report by the device.

In another implementation, a computer-implemented method for predicting parking availability based on historical demand data is disclosed. The method comprises receiving, at a computer server system from one or more mobile computing devices, requests for a reporting of open parking spots in a given area; identifying respective times at which the requests were received; calculating a historical demand for parking in the given area for one or more periods of time based at least in part on the requests and the identified times; and determining a likelihood that one or more parking spots are open in the given area during the one or more periods of time based at least in part on the historical demand. The method may further comprise providing a graphical representation of the likelihood, and the graphical representation can comprise a map for display on one or more mobile computing devices.

In yet another implementation, a system for tracking parking spot availability is disclosed and includes a server system interface arranged to receive reports from mobile devices, the reports indicating geographic locations of open parking spots at current locations of the mobile devices; one or more timers for determining elapsed times relative to reports of open parking spots reported by the mobile devices; an open spot identifier programmed to respond to requests from computing devices to identify open spots in particular geographic areas, the open spot identifier using the reports and the elapsed times to identify spots likely to be open and geographic locations of the spots likely to be open; and a server system interface programmed to provide to requesting mobile devices data formatted for display on maps of geographic areas that correspond to identified spots likely to be open. The one or more timers can be programmed to compute elapsed time by identifying differences between times associated with reports from the mobile devices, and times associated with requests to identify open spots. Also, reports from the mobile devices are triggered automatically based on movement of the mobile devices that is sensed automatically by the mobile devices.

In certain aspects, the computer server system is programmed to not maintain an association between the mobile computing device and parking data received from the mobile computing device. The system can also include a database that indicates whether parking spots are public parking spots, and can further include an historical demand calculator programmed to identify a historical demand over defined time periods for parking in a given area for one or more periods of time based at least in part on requests received by mobile devices and times at which the requests were received. In addition, the open spot identifier can be programmed to determine a likelihood that one or more parking spots are open in the given area during one or more periods of time based at least in part on the historical demand. In addition, the system can include a turn-by-turn navigation generator programmed to provide for mobile devices data for generating turn-by-turn directions to parking spots identified as being likely open.

In yet another embodiment, a computer-implemented method for tracking parking spot availability is disclosed, and comprises providing from a first computing device to a computer server system a request to receive information about open parking spots in a geographic area; receiving in response from the computer server system data indicating locations of likely open parking spots, the likely open parking spots being determined by elapsed time since reports from other mobile devices at locations of the likely open parking spots; and displaying a map on the first computing device that indicates locations of the likely open parking spots. The method can also include submitting, from the computing device to the computer server system, a report of an open parking spot. The report can be generated automatically by the computing device based on the computing device determining that it has been moved in a predetermined manner, or in response to a velocity of the mobile computing device increasing above a threshold value for a predetermined length of time. The method can also include receiving from a user of the computing device input that indicates layers of information the user desires to see on the computing device, and changing content types that are displayed to the user on a map on the computing device in response. Moreover, the method can include automatically fetching from the computer server system information for a selected layer.

Any of the implementations discussed above may also be implemented as one or more tangible non-transitory computer-readable storage mediums having recorded thereon instructions that when executed perform various operations, including the various operations discussed above.

The details of one or more embodiments are set forth in the accompanying drawings and the description below. Other features and advantages will be apparent from the description and drawings, and from the claims.

### DESCRIPTION OF DRAWINGS

FIG. 1 shows an example user interface for displaying parking data.

FIG. 2A shows an example user interface for displaying parking data.

FIG. 2B shows an example user interface for displaying parking data.

FIG. 3A shows an example flow of information between mobile computing devices and a server.

FIG. 3B shows an example user interface progression.

FIG. 4 is a schematic diagram of a system for providing information to a user of a mobile device.

FIG. 5 is a flow chart of an example process for performance on a smartphone or similar computing device.

FIG. 6 is a flow chart of an example process for performance on a smartphone or similar computing device.

FIG. 7 is a conceptual diagram of a system that may be used to implement the systems and methods described in this document.

FIG. 8 is a block diagram of computing devices that may be used to implement the systems and methods described in this document, as either a client or as a server or plurality of servers.

Like reference symbols in the various drawings indicate like elements.

### DETAILED DESCRIPTION

This document describes systems and techniques for reporting to users of portable computing devices, such as smartphones, the locations of parking spots that are likely to be open in the geographic areas of such user. For example, icons may be shown at locations of likely open spots, as superimposed on a mapping application that may also shown map or satellite views of an area, including an area that is automatically selected to be around a current location of a user. Such icons may be provided as a selectable layer of a mapping application, and multiple parking-related layers or sub-layers may also be provided, including layers that show free or paid parking, and other similar information.

A hosted server system can obtain from various other computing devices information for determining where there are locations of parking spots that are likely to be open. Such information may be generated by such devices automatically (e.g., if they are running a compatible app, or application), such as when the devices sense that they are moving after having been stopped for a time period, so as to infer that they are leaving a parking spot. A server system may receive such reports, check them against a database of known parking spots, and list them as open for a determined time period which may be set or variable. For example, during busy times (morning and afternoon rush hour, or dinnertime in an entertainment district), a server system may report a spot in an urban area as being open for only 2 minutes, while it may keep the spot as being indicated open for 10 minutes in quieter parts of the day. Such time periods may be learned by the system over time by analyzing relative progress and timing of reports so as to infer how busy certain geographic areas are in opposition to other areas, and how busy particular geographic areas are during different times of the day, different days of the week, and different seasons of the year (e.g., parking may be busier in the summer in cold climates). Particular implementations of the concepts discussed here are provided with respect to each of the accompanying figures.

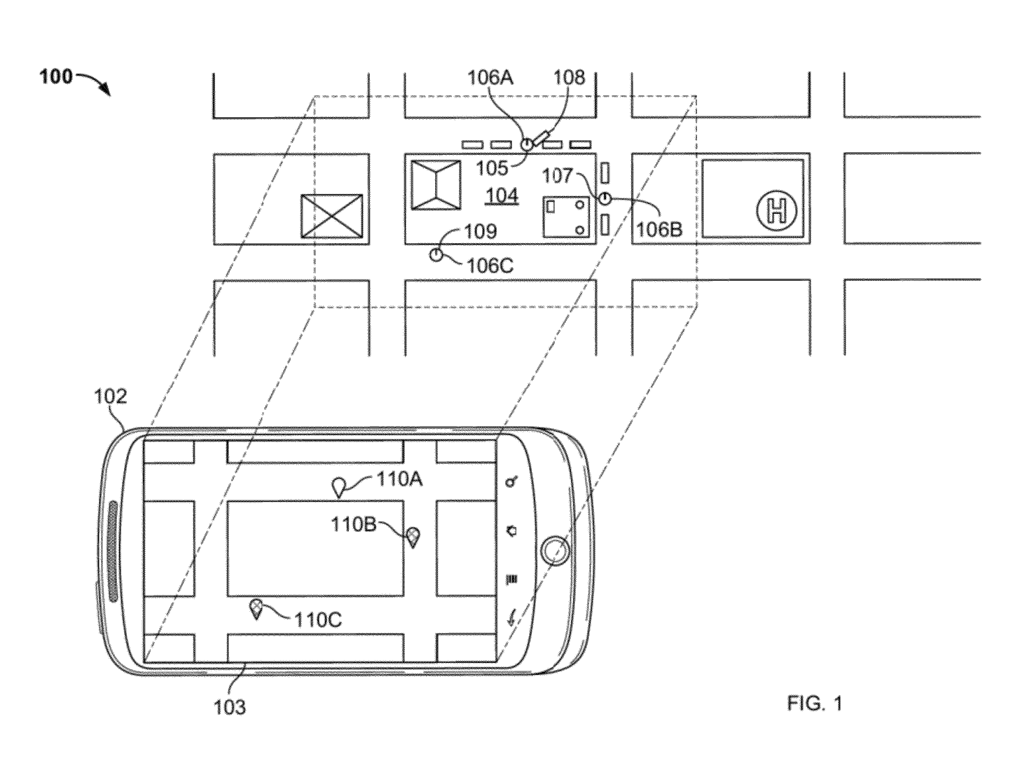

FIG. 1 shows a scenario 100 that illustrates respective states of three parking spots 105, 107, and 109 that are located around a building 104. The real-life scenario is depicted schematically on a map, and is joined to a virtual representation of the scenario on a mapping application that is displayed by a computing device 102.

In the scenario 100, the amount of time each parking spot has been “open” is represented by a virtual timer 106A, 106B, or 106C. For example, in the scenario 100, a car 108 is shown as beginning to depart the first parking spot 105 on the north side of the block 104. Accordingly, as the first parking spot 105 has only just been vacated, its corresponding timer 106A shows that almost no time has passed since the first parking spot has become an “open” or “available” parking spot. To represent this state of the first parking spot 105A, a hand of the timer 106A is shown to be substantially located at an initial position (e.g., at the “twelve o'clock” position on the face of the timer 106A). Similarly, the second parking spot 107 located on the East side of the block 104 has been vacant for a slightly longer time and, as such, its corresponding timer 106B has its hand in a position that is advanced relative to the position of the hand in timer 106A (e.g., at the “one o'clock position”). The state of the timer 106B can represent, for example, that the second parking spot 107 has been open for approximately five minutes.

The third parking spot 109 located on the South side of the building 104 has been open longer than either the first parking spot 105 or the second parking spot 107. For example, the third parking spot 109 could have been vacated ten minutes (or more) ago by its previous occupant. Thus, a hand of timer 106C is shown in a position that is more advanced than the hands of the other two timers 106A, 106B (e.g., the hand of the timer 106C is located at the “three o'clock position”)—so as to visually represent this additional elapsed time.

FIG. 1 also shows the mobile computing device 102 (e.g., a cell phone, a PDA, a navigation system in an automobile, or a laptop computer) that includes a graphical user interface 103. The mobile computing device 102 may be a device that is in the possession of a user who is looking for open parking in the area displayed here, such as someone who is going shopping and is approaching the area in his or her car

In this example, the graphical user interface 103 is providing a road map associated with an application (e.g., a parking tracking application) running on the mobile computing device 102. The road map and its accompanying details illustrated by the graphical user interface 103 can portray various aspects of the scenario 100. For example, the graphical user interface 103 provides markers 110A, 1108, and 110C that each represent the state of a potential open parking space. In this example, the marker 110A corresponds to a state of the first parking space 105, the second marker 1108 corresponds to the second parking space 107, and the third marker 110C corresponds to the third parking space 106C.

In some examples, the markers 110A-C are graphical representations of the abstract timers 106A-C discussed above with regard to the scenario 100 and as displayed in the area in the figure. In this particular example, the markers 110A-C take the form of pins that are colored, shaded, or hashed so as to indicate a current status of each of the spots. For example, the marker 110A is shown as being unhashed (e.g., relative to the markers 110B and 110C), which may represent that its corresponding parking spot (i.e., the first parking spot 105) was recently vacated. That is, the amount of time that the first parking spot 105 has been open may fall below a threshold value (e.g., one minute), and an appropriate marker can then be displayed on the graphical user interface 103 to represent the presence of a recently-vacated parking spot.

The markers 110B and 110C graphically represent the state of the second parking spot 107 and the third parking spot 109, respectively. For example, the markers 110B and 110C are both shown hashed so as to represent different colors for the markers 110B and 110C. As one example, the markers 110A-C may turn from green, to yellow, to red so as to indicate elapsed time since a spot was last determined to have been vacated, and to thus convey to a user of the device 102 the odds that the spot will still be open (where red, a universal indication of “stop,” represents bad odds).

Thus, as shown here, the vacating of parking spots can be identified by a system that may indicate those spots as being open for a determined period of time. The determination that a spot has been vacated may be based on a determination that a mobile device move out of a spot and quickly down a roadway (by comparing the location of the device to map data and identifying that the device was on the edge of a road and then moved down the road). The indication may be provided to other users of mobile devices, as a graphical indicator on a map of the area—where multiple graphical indicators may indicate different spots, and the indicators may change their appearance over time (e.g., they may visually decay or change colors) as the spot has been vacated for a longer period of time (so as to indicate a higher likelihood that someone who does not have a device communicating with the system has taken the spot).

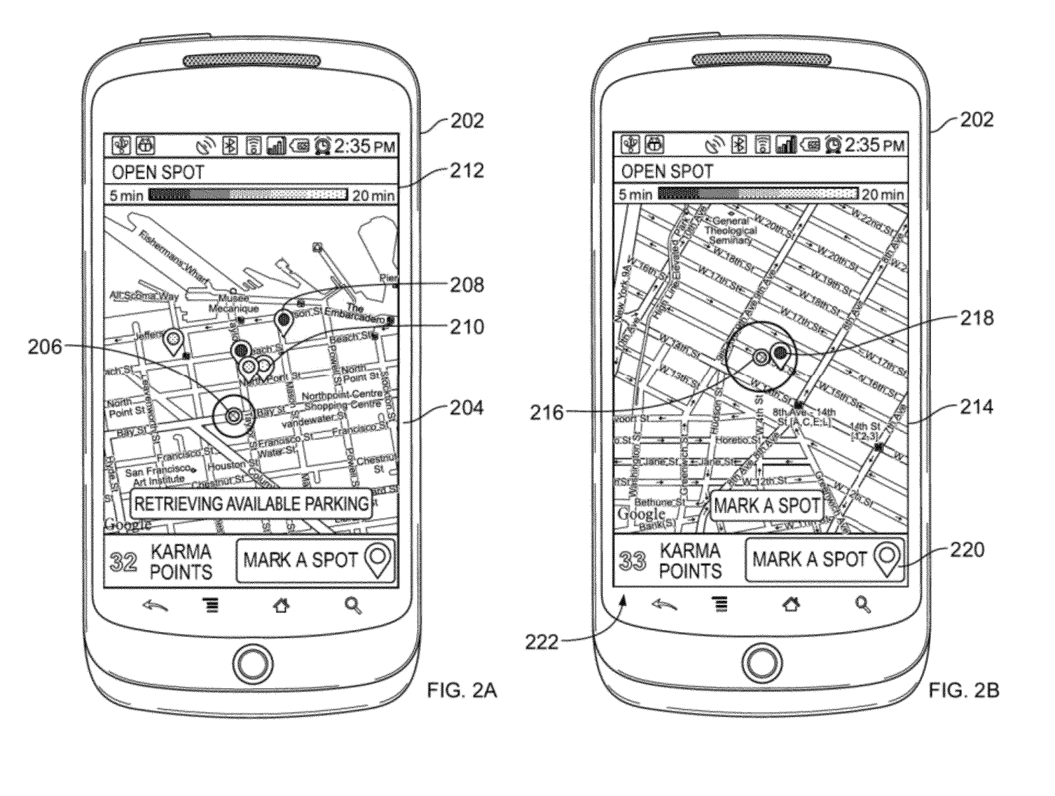

FIGS. 2A and 2B show screenshots of a parking tracking application running on a mobile computing device 202. In FIG. 2A, a graphical user interface 204 is displaying an enhanced road map that is associated with the parking tracking application. The parking information may be implemented, for example, as a particular visual layer of a more general mapping application—and when the layer is turned on, icons for parking spots will be displayed along with other graphical elements, and user-selectable controls for interacting with the parking tracking application. In this example, the parking tracking application is operating in a mode that allows a user to identify open parking spaces in a particular area (e.g., within a certain distance of the user, within a certain area of a city, or within a certain distance from a landmark). For example, the enhanced roadmap shows a user indicator 206 that represents a current position of the mobile computing device 202 (e.g., using GPS technology, as described in greater detail below), and also displays five open parking spots, including parking spots 208 and 210. As demonstrated by the legend 212, parking spot 208 has been open for a short amount of time (e.g., five minutes or less), while parking spot 210 has been open for a relatively long time (e.g., twenty minutes or more).

The states of the indicators that represent the parking spots can change according to the scale represented by the legend 212, and can be removed entirely after a predetermined amount of time has elapsed. For example, the parking spot 210 can be removed from a list of open parking spots after being marked as open for two hours. This policy may reflect the low-likelihood that a parking space would remain open for more than two hours. The predetermined amount of time can vary based on locale; for example, a parking spot may be removed after only thirty minutes in a busy part of a large city, but may remain open for two hours in a more rural area. Similarly, while the legend 212 may represent a range of five minutes to twenty minutes in the example of FIG. 2A, this range (and its increments) can be altered based on location information, user preferences, and other factors.

The speed with which an open spot decays and is eliminated can be based on learned historical activity for an area around the spot. For example, where one user who has a device that is active with the system leaves a spot, and another active device enters the spot a short time later, an inference may be made that the spot stayed open for at least that amount of time. The amount of time (when aggregated with many other such vacate-refill episodes for spots n the same area and across a large area) may then be correlated with the time of day and the day of the week to identify refill speed for an area around the spot. The refill speed may also be compared with refill speeds for various other location in order to estimate adjustments that need to be made from the data derived from users of device-equipped and enrolled cars, to better reflect the activity of all users and a real average refill speed. For example, it may be determined that refill speeds for device users generally underreport the real-life refill speed by 20%, so that a system may increase its computed refill speed by a corresponding percentage in order to better report on the likelihood that a space will still be open.

Activation of an indicator that represents an open parking space can cause the mobile computing device to provide details about the parking space. In some examples, the parking space details includes pricing information (e.g., if the parking space requires a fee), time limit information (e.g., if the parking space has a limit on the amount of time that a driver may park in the parking space), or ownership information (e.g., whether the parking space is a public space, or a private space requiring a parking pass, decal, or permit). Users can also filter the parking spots that are displayed on the enhanced road map using the parking space details, or other information such as safety (e.g., parking spots that are located in low crime areas or near police stations, or proximity to a landmark (e.g., parking spots that are located near a venue that the user plans to attend after parking his vehicle).

Activation of an indicator that represents a parking spot may also initiate a navigation program that provides turn-by-turn directions to the parking spot. For example, after the mobile computing device 202 (or a server in communication with the mobile computing device 202) has identified a location for a parking spot associated with the activated indicator, (i.e. a destination for the navigation), it may generate a route between the mobile computing device's 202 current location 206 and the destination. The route can then be provided to a user who is using a combination of graphical cues (e.g., maps) and audio cues (e.g., a voice instruction to “turn right in two miles”).

FIG. 2B shows an exemplary graphical user interface 214 that shows a current position 216 of the mobile computing device 202 as well as a parking spot 218 that the mobile computing device 202 has recently “marked.” FIG. 2B represents an exemplary manner in which the mobile computing device 202 (sometimes in combination with a parking tracking application) may be used to gather information that identifies open parking spots. The mobile computing device 202 can use a variety of techniques to mark open parking spots. For example, if a user of the mobile computing device sees an open parking spot while walking, driving, or otherwise, the user may activate a mark control 220 within the parking tracking application to provide a location of the open parking spot to a parking server (e.g., a remote entity that interacts with a plurality of mobile computing devices to collect, maintain, and provide information that can be used to administer a parking tracking application). For example, if the mobile computing device 202 is located near the open parking spot, providing a location of the open parking spot can include sending a GPS coordinate of the mobile computing device 202 to the parking server when the user selects the mark control 220.

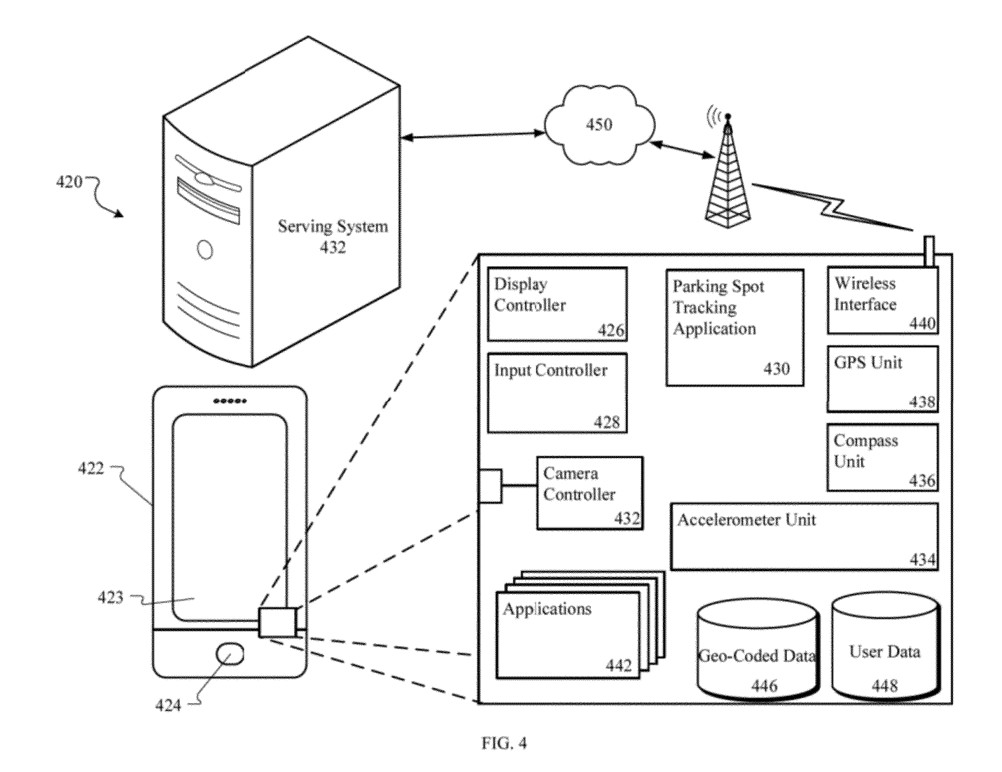

Other techniques can also be used to mark open parking spots. In some examples, reports can be automatically triggered by movement of the mobile computing device 202. For example, the mobile computing device 202 may contain an accelerometer (e.g., accelerometer unit 434 (FIG. 4)) that measures an amount of vibration or movement of the mobile computing device 202. The mobile computing device 202 can use these measurements to automatically trigger the generation of a report that includes the location of an open parking spot. In some examples, the mobile computing device 202 could register an “intent” (i.e., a programming facility to allow one application to bind itself to another application so as to be informed when certain event occur) with its operating system or another application to cause the generation of a notification when a vibration of the mobile computing device 202 exceeds a threshold value, or matches a predefined vibration profile. This notification could represent that a user has begun to travel in a vehicle, causing a particular mode of vibration. By triggering a notification at a time when a user is potentially beginning to travel in a vehicle, the notification can represent that a user (along with his mobile computing device 202) has entered a vehicle in a parking spot and then subsequently left that parking spot, leaving it open. Thus, an “open spot” report can be generated based on the notification that results from the intent registered with the operating system, and the open spot can be registered and marked on the parking server.

In some examples, the velocity of the mobile computing device 202 can be used in order to automatically generate notifications and open parking spot reports. For example, the mobile computing device 202 can determine its velocity using a plurality of GPS readings. An intent registered with the operating system of the mobile computing device 202 can cause a notification to be generated when the velocity of the mobile computing device 202 exceeds a threshold value (or that the velocity has changed by a threshold value). The mobile computing device 202 can use the velocity measurements to determine whether a user has entered a vehicle at a velocity near zero (e.g., while the vehicle is parked) and has subsequently begun to drive away from a parking spot. Again, by triggering a notification at a time when a user is potentially beginning to travel in a vehicle, the notification can represent that a user (along with his mobile computing device 202) has entered a vehicle in a parking spot and then subsequently left that parking spot, leaving it open. Thus, an “open spot” report can be generated based on the notification that results from the intent registered with the operating system, and the open spot can be registered and marked on the parking server.

Other factors can affect whether a notification and/or an open parking spot report are automatically generated. For example, the mobile computing device 202 can be configured to require that the threshold vibration frequency or the threshold velocity continue for a threshold length of time (e.g., ten seconds). The location of the mobile computing device 202 can also be cross-referenced with locations of known parking spots (and with locations that are devoid of parking spots, such as highways) in order to prevent the accidental marking of an open parking spot when, for example, a user begins driving after being stopped in a traffic jam on a highway. Also, in some examples, a notification can cause a generation of an opportunity to confirm or prevent the generation of an open parking spot report. For example, if a velocity notification is generated after a user has entered a parked vehicle and driven away from the parking spot at a threshold velocity, the notification may result in a challenge being presented on a graphical user interface of the mobile computing device 202. The challenge may ask the user whether an open parking spot report should be submitted to the parking server. If the user responds in the affirmative (e.g., by activating a “confirm” option associated with the challenge), the report can be generated and/or submitted to the parking server. If the user responds in the negative (e.g., by activating a “cancel” option associated with the challenge, a generation and/or submission of the report can be prevented.

After a user has marked an open parking space, an account associated with the user and/or the mobile computing device 202 can be rewarded. For example, the parking server may award a parking spot tracking account associated with the mobile computing device 202 one or more “karma points” 222. In some examples, karma points 222 are a numerical representation of the number of times that a user has marked open parking spots using the parking spot tracking application. If a user accumulates a threshold level of karma points, other rewards can be provided to the user. For example, if a user accumulates fifty karma points, a user can be provided with access to enhanced features within the parking spot tracking application (e.g., a user can be allowed to view more open parking spots than users with fewer karma points), or can be provided with titles/honorifics, electronic trophies, electronic badges, or other items that represent a user's satisfaction of a karma point milestone.

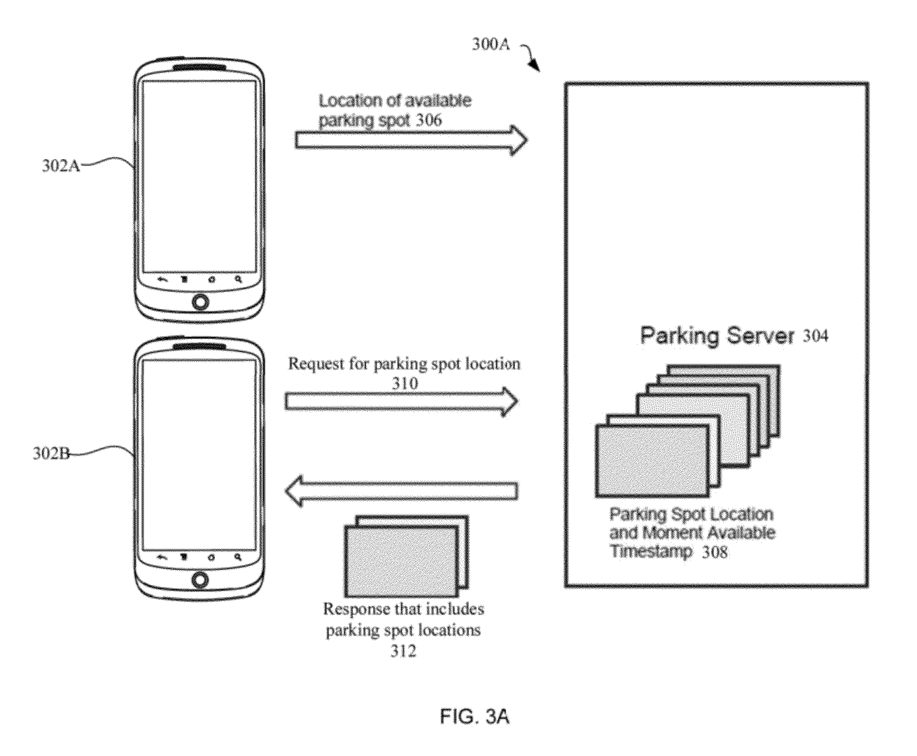

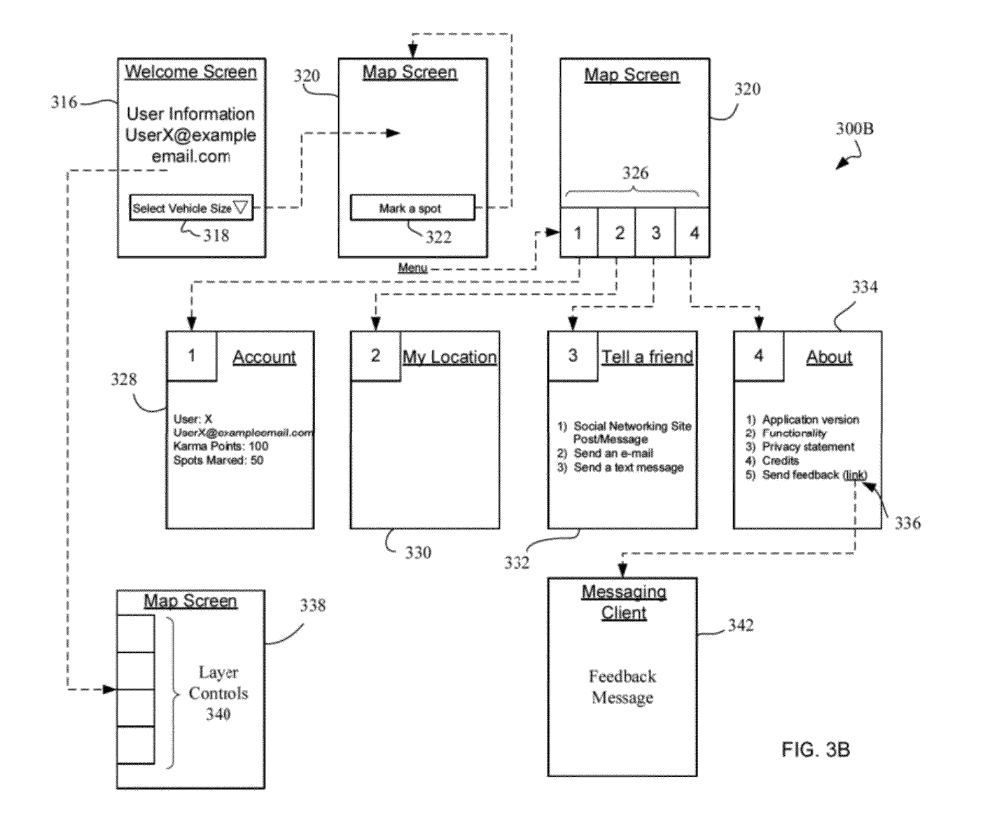

FIG. 3 is a block diagram of a workflow within a system 300 for marking, requesting, and receiving the locations of one or more open parking spots. The system 300 includes two mobile computing devices 302A and 302B which, in this example, are smartphones. As discussed above, mobile computing devices can mark open parking spots and can request and receive the locations of open parking spots (e.g., parking spots that have been marked as open by another mobile computing device). The system 300 also includes a parking server 304 for communicating with the mobile computing devices 302A and 302B and for storing, organizing, and serving content associated with the tracking of parking spots.

The parking server 304 receives a message that includes the location of an available parking spot from the mobile computing device 302A (306). The message containing the location of the available parking spot can include a GPS location of the parking spot, a size of the parking spot (e.g., a “compact car” parking spot) and a timestamp that identifies when the parking spot was marked (e.g., marked using one or more of the techniques described above). The parking server 304 adds the identified parking spot to a database of parking spots along with the received time stamp that identifies the moment the parking spot was marked (308). The parking server 304 may further organize the received parking spot locations according to their GPS locations, city, state, size, or other metric. The parking server 304 (or the parking tracking application) may also identify additional information about the marked parking spot, such as whether the marked parking spot is a public spot, a private spot, or whether a permit, sticker, or pass is required to utilize the parking spot.

The parking server 304 receives a request for a parking spot location from a mobile computing device 302B (310). The request may include the location of the mobile computing device 302B (e.g., as a GPS coordinate), and may also include one or more other preferences selected by a user of the mobile computing device 302B, such as a desired parking spot price range, a desired parking spot size, and a desired park time limit. These preferences may also be stored in an account associated with the mobile computing device 302B on the parking server 304 or on another computing entity.

The parking server 304 uses information received in the request and/or information associated with an account of the mobile computing device 302B (e.g., user preferences) in order to identify parking spots that match the criteria. If the parking server 304 identifies one or more suitable parking spaces, the parking server transmits a response that includes a list of available parking spaces to the mobile computing device 302B (312). The response may include further information about some or all of the parking spaces, such as prices, parking spot sizes, and parking spot time limits. The available parking spaces can then be displayed on a graphical user interface associated with the mobile computing device 302B (e.g., in the manner shown in FIG. 2A).

FIG. 3B is a block diagram of a progression 300B of user interface screens that can be displayed, for example, on a graphical user interface of a mobile computing device 302B. In general, the screens are associated with a parking tracking application running on the mobile computing device 302B.

Welcome screen 316 may be presented to a user upon start-up of the parking tracking application. The welcome screen 316 can display information associated with an account of the user, such as an email address and a user name. The welcome screen 316 can also invite a user to select a vehicle size using a vehicle size control 318 (e.g., a drop-down list). Exemplary vehicle sizes are “motorcycle,” “compact,” “standard,” “SUV,” and “oversized.” Activation of the vehicle size control 318 can cause the mobile computing device 302B to advance to a map screen 320. The map screen 320 may show an enhanced street map in a region near a location of the mobile computing device 302B (e.g., with the map centered on the mobile computing device 302B). The map screen may resemble the screens shown in FIGS. 2A and 2B, and may include a mark control 322 for marking an open parking spot, or a search control (not shown) for initiating a search for open parking spots. In some examples, activation of the mark control 322 can place a marker on the enhanced street map that represents the marked parking spot.

A user can also progress from the welcome screen 316 to a map screen 338 that includes layer controls 340. The layer controls may operate in a familiar manner to allow a user to have certain defined types of information shown or not shown on a map. For example, one layer might show free parking, while another might show parking on the street, in garages, or at meters. Also, a user may select other parameters to affect the information that is displayed to them, such as by altering a distance of parking from the current location that will be treated as eligible parking for them (e.g., a slider may be provided by which the user may define the radius of a circle around them to check for open spots).

Activation of a menu control 324 (e.g., a hard or soft key located on the mobile computing device 302B) can cause the mobile computing device 302B to display a number of additional controls 326 (e.g., controls “1,” “2,” “3,” and “4”). The additional controls 326 can be overlayed on the map screen 320 (e.g., displayed in a layer on top of the map layer). In some examples, activation of one of the additional controls 326 will cause the mobile computing device 302B to progress to a new screen. For example, activation of the additional control 326 labeled “1” can cause the mobile computing device 302B to display an account screen 328. The account screen includes information about a user account associated with the mobile computing device 302B, and may resemble the welcome screen 316 in some regards. The account screen 328 can further include a number of karma points earned by the user to date, and a number of parking spots marked by the user.

Activation of the additional control 326 labeled “2” can cause the mobile computing device 302B to display a “my location” screen 330. The my location screen 330 can result from a my location action that causes a map to be re-centered on the user's current location, i.e., the location of the mobile computing device 302B. For example, a user may begin a session with the map centered on their current location and may then pan around the map to see if there is parking in their general area. Such panning may cause them to lose track of where they are on the map, and performance of a my location action may pan the map back to displaying their current location.

Activation of the additional control 326 labeled “3” can cause the mobile computing device 302B to display a “tell a friend” screen 332. In some examples, the tell a friend screen 332 can include a number of controls for sharing the parking tracking application with contacts of the user. For example, the tell a friend screen 332 can include controls for sharing the parking tracking application by transmitting 1) a social networking site post or message; 2) an email; and/or 3) a text message (e.g., an SMS message). Activation of the additional control 326 labeled “4” can cause the mobile computing device 302B to progress to an “about” screen 334. In some examples, the about screen 334 includes information about a version of the parking tracking application and functionality of the parking tracking application (e.g., version features and/or a help document).

The about screen 334 can also include a control for accessing a privacy statement associated with the parking tracking application. The privacy statement can provide, for example, that parking data will not be saved (e.g., by the parking server 304 or otherwise) in a manner that would allow the parking data to be associated with individual users. The privacy statement may also provide that temporary files containing parking data submitted by users is purged after the raw parking data has been stored. In some examples, the about screen 334 can also provide a control for viewing “credits” associated with the parking tracking application (e.g., allowing the user to view the members of the team associated with producing the parking tracking application). The about screen 334 may also include a control that, when activated, allows users to provide feedback about their experiences with the parking tracking application. For example, the about screen 334 includes a feedback control 336 that, when activated, generates a pre-addressed message in a messaging client 342 (e.g., a text message editor or an email editor) where a user can provide comments about the parking tracking application. The particular options that are provided, and the manner for setting levels for information control, may vary with each implementation.

FIG. 4 is a block diagram of a mobile device 422 and system 420 for providing navigation information to a user of the device 422. In general, the system 420 includes software operating on the device 422 in cooperation with software at a server system 432 executing a hosted version of a navigation application. In such an example, the device 422 may interact with a user, and may transmit information for various pieces of the processing to be performed on the server system 432, such as speech-to-text conversion, converting search queries into geographic locations such as in a lat/long format, and serving map tile or images in coordination with data that may permit a navigation application 430 executing on the device 422 to interact with a user in the manners described above and below.

In the example shown, the mobile device 422 is a smartphone. In other implementations, the mobile device 422 can be an in-dash vehicle navigation device (which may provide navigation functions and additional computing functions, including auto stereo control, maintenance warnings and the like), a personal digital assistant, a laptop computer, a net book, a camera, a wrist watch, or another type of mobile electronic device. The mobile device 422 includes a camera and a display screen 423 for displaying text, images, and graphics to a user, including images captured by the camera. In some implementations, the display screen 423 is a touch screen for receiving user input. For example, a user contacts the display screen 423 using a finger or stylus in order to select items displayed by the display screen 423, enter text, or control functions of the mobile device 422. The mobile device 422 further includes one or more input devices such as a track ball 424 for receiving user input. For example, the track ball 424 can be used to make selections, return to a home screen, to scroll through multiple items in a group, or to control functions of the mobile device 422. As another example, the one or more input devices includes a click wheel for scrolling through menus and text.

The mobile device 422 includes a number of modules for controlling functions of the mobile device 422, including modules to control the receipt of information and triggering the providing of navigation services to a user of the mobile device 422. The modules can be implemented using hardware, software, or a combination of the two. The mobile device 422 includes a display controller 426, which may be responsible for rendering content for presentation on the display screen 403. The display controller 426 may receive graphic-related content from a number of sources and may determine how the content is to be provided to a user. For example, a number of different windows for various applications 442 on the mobile device 422 may need to be displayed, and the display controller 426 may determine which to display, which to hide, and what to display or hide when there is overlap between various graphical objects. The display controller 426 can include various components to provide particular functionality for interacting with displayed components, which may be shared across multiple applications, and may be supplied, for example, by an operating system of the mobile device 422.

An input controller 428 may be responsible for translating commands provided by a user of mobile device 422. For example, such commands may come from a keyboard, from touch screen functionality of the display screen 423, from trackball 424, or from other such sources, including dedicated buttons or soft buttons (e.g., buttons whose functions may change over time, and whose functions may be displayed on areas of the display screen 403 that are adjacent to the particular buttons). The input controller 428 may determine, for example, in what area of the display commands are being received, and thus in what application being shown on the display the commands are intended for. In addition, it may interpret input motions on the touch screen 423 into a common format and pass those interpreted motions (e.g., short press, long press, flicks, and straight-line drags) to the appropriate application. The input controller 428 may also report such inputs to an event manager (not shown) that in turn reports them to the appropriate modules or applications. For example, a user viewing an options menu displayed on the display screen 423 selects one of the options using one of the track ball 424 or touch screen functionality of the mobile device 422. The input controller 428 receives the input and causes the mobile device 422 to perform functions based on the input.

A variety of applications 442 may operate, generally via a common microprocessor, on the mobile device 422. The applications 442 may take a variety of forms, such as mapping and navigation applications, e-mail and other messaging applications, image viewing and editing applications, video capture and editing applications, web browser applications, music and video players, and various applications running within a web browser or running extensions of a web browser. In certain instances, one of the applications, a navigation application 430, may be programmed to communicate information to server system 432 (e.g., the parking server 304) via network 450.

A wireless interface 440 manages communication with a wireless network, which may be a data network that also carries voice communications. The wireless interface 440 may operate in a familiar manner, such as according to the examples discussed below, and may provide for communication by the mobile device 422 with messaging services such as text messaging, e-mail, and telephone voice mail messaging. In addition, the wireless interface 440 may support downloads and uploads of content and computer code over the wireless network. The wireless interface 440 may also communicate over short-range networks, such as with other devices in the same room as device 422, such as when results are provided to the device 422 and need to be forwarded automatically to another device in the manners discussed above and below.

A camera controller 432 of the mobile device 422 receives image data from the camera and controls functionality of the camera. For example, the camera controller 432 can receive image data for one or more images (e.g. stationary pictures or real-time video images) from the camera and can provide the image data to the display controller 426 and/or to one or more of the application 442.

Still referring to FIG. 4, in accordance with some implementations, the navigation application 430 uses a GPS Unit 438 of the mobile device 422 to determine the location of the mobile device 422. For example, the GPS Unit 438 receives signals from one or more global positioning satellites, and can use the signals to determine the current location of the mobile device 422. In some implementations, rather than the GPS Unit 438, the mobile device 422 includes a module that determines a location of the mobile device 422 using transmission tower triangulation or another method of location identification. In some implementations, the mobile device 422 uses location information that is determined using the GPS Unit 438 to identify geo-coded information that is associated with the location of the mobile device 422. In such implementations, location information obtained or determined by the GPS Unit 438 is provided to the navigation application 430. In some implementations, the navigation application 430 uses the location information to identify geo-coded data 446 stored on the mobile device 422.

The geo-coded data 446 includes information associated with particular geographic locations. For example, geo-coded data can include building names, business names and information, historical information, images, video files, and audio files associated with a particular location. As another example, geo-coded data associated with a location of a park may include hours for the park, the name of the park, information on plants located within the park, information on statues located within the park, historical information about the park, and park rules (e.g. “no dogs allowed”). The geo-coded information can also include map tiles or digital images to be displayed to a user of the device 422.

The navigation application 430 can use the current location of the mobile device 422 to identify information associated with geographic locations that are in close proximity to the location of the mobile device 422, such as for annotating a display of a navigation application with information such as information for local businesses that a user may want to visit. In some implementations, the geo-coded data 446 is stored on a memory of the mobile device 422, such as a hard drive, flash drive, or SD card. In some implementations, the mobile device 422 may contain no pre-stored geo-coded data. In some implementations, none of the geo-coded data 446 stored on the mobile device 422 is associated with locations within relative proximity to the current location of the mobile device 422. The geographical information can be used in various ways, such as passing the data to the central server system 432, so that the central server system may identify a current location of the mobile device and thereby set that location as an initial location, or may know which navigation to pass to the mobile device 422 as the device moves.

The device 422 uses a compass unit 436, or magnetometer, in some examples, e.g., to determine a current viewing direction of a camera on the device 422, within the horizontal plane, of the camera. In other words, the compass unit 436 determines a direction in which a user of the mobile device 422 is looking with the mobile device 420. Viewing direction information provided by the compass unit 436 can be used if the device 422 passes an image to the server system 432, such as for purposes of the submitting a query to the server system 432, or for adding the image to a collage of images at the location from multiple users. In some implementations, the mobile device 422 further includes an accelerometer unit 434 or a gyroscope that may be further used to identify a user's location, movement, or other such factors.

Still referring to FIG. 4, in accordance with some implementations, the mobile device 422 includes user data 448. The user data 448 can include user preferences or other information associated with a user of the mobile device 422. For example, the user data 448 can include a number of locations that the user has visited recently so that those locations can be suggested over others by a navigation system (and can be added to a speech-to-text grammar if the user input is verbal). The user data 448 may also indicate the manner in which the user wants navigation information displayed. For example, the user may always want to see a map view or a satellite view, or the user may establish pre-sets so that maps views are displayed under certain conditions and street views are displayed under other conditions.

The navigation application 430, which may run in a browser or be a stand-alone application, can interact with the server system 432 in a variety of manners. For example, in collecting spoken input from a user, the device 432 may provide a general application in the operating system for converting spoken input to text. The server system 432 may recognize a carrier phrase in the input and may use that carrier phrase to select an application to which the input was directed, and may pass an identifier for the application (e.g., the navigation application 430 is the carrier phrase was “navigate to”) back to the device 423 along with the rest of the input in textual form. The navigation application may then pass the text back up to the server system 432 as a query that can be analyzed by the server system 432 to identify, e.g., a target for a navigation. Alternatively, the server system may perform the text-to-speech and determine the location information without first passing the text back to the device 422. The navigation application 430 may then wait to receive code and other data for interacting with the user for the navigation, such as in the manners discussed above and below. For example, the navigation application may receive map tiles or street-level images along with data specifying geographic locations for those objects. The navigation application may then use such information to generate an interactive navigation experience for the user of the device 422.

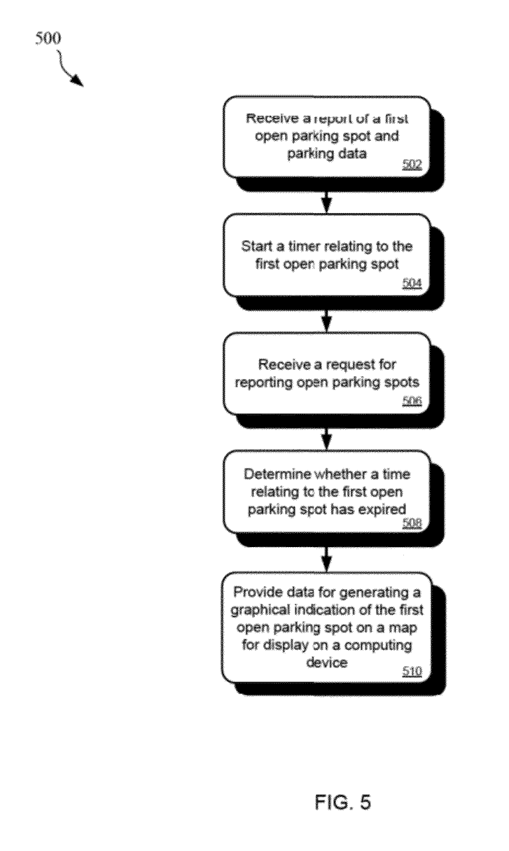

FIG. 5 shows an exemplary process 500 for tracking parking spot availability. In some examples, the process 500 can be carried out on a remote server in communication with one or more mobile computing devices, such as parking server 304 (FIG. 3A).

A report of a first open parking spot and parking data are received (502). In some examples, the parking server 304 receives a report that is generated based at least in part on a movement of the mobile computing device. For example, as described above, the report can be generated based on a vibration or velocity of the mobile computing device. The report can include a timestamp that represents a time at which the report was generated and/or submitted. The parking data may, in some cases, indicate a location of the first open parking spot (e.g., in the form of one or more GPS coordinates).

A timer is started relating to the first open parking spot (504). For example, the parking server 304 may initiate a timer that runs from the time at which the report was received, generated, or submitted.

A request is received for reporting open parking spots (506). For example, the parking server 304 may receive a request from a mobile computing device running a parking tracking application for the identification of one or more open parking spots in the vicinity of the mobile computing device. The request may include a number of user preferences that relate to a desired price, time limit, size, and/or location of parking spaces. In some examples, the request can be generated at a mobile device of another user that is running a parking application.

It is determined whether a time relating to the first open parking spot has expired (508). For example, the parking server 304 may reference a timer associated with the first parking spot to determine whether the elapsed time exceeds a threshold value. For instance, if the parking server 304 determines that a parking spot has been marked as an open parking spot for longer than twenty minutes, the parking server 304 could infer that the parking spot is (most likely) no longer available. This determination reflects the logic that after a parking spot becomes available, the likelihood of the parking spot remaining open decreases with the passage of time.

In some examples, the parking server 304 may compare the elapsed time associated with the first parking spot to multiple thresholds that each represent a different state. For example, the parking server 304 could determine whether the elapsed time exceeds a first, second, or third threshold, where the first threshold represents parking spots that are “likely available,” the second threshold represents parking spots that are “possibly available,” and the third threshold represents parking spots that are “likely unavailable.”

Data is provided for generating a graphical indication of the first open parking spot on a map for display on a computing device (510). For example, if the parking server 304 identifies a threshold that the elapsed time of the first parking spot exceeds, the parking server 304 may cause a user device associated with the request to display a marker that represents the first parking spot's likelihood of availability (e.g., based on the characteristics represented by the threshold). For example, if the elapsed time exceeds the third threshold mentioned above (e.g., a parking spot that is likely unavailable), the parking server 304 may cause the marker associated with the first parking spot to appear as a red colored marker to denote the status of the first parking spot as a spot that is likely to have been filled by another vehicle.

The parking server 304 may also provide other information about the first parking spot that can be graphically represented on a mobile computing device of a user who is looking for a parking spot. For example, the parking server 304 may provide information concerning the price, time limit, size, and/or ownership of the first parking space.

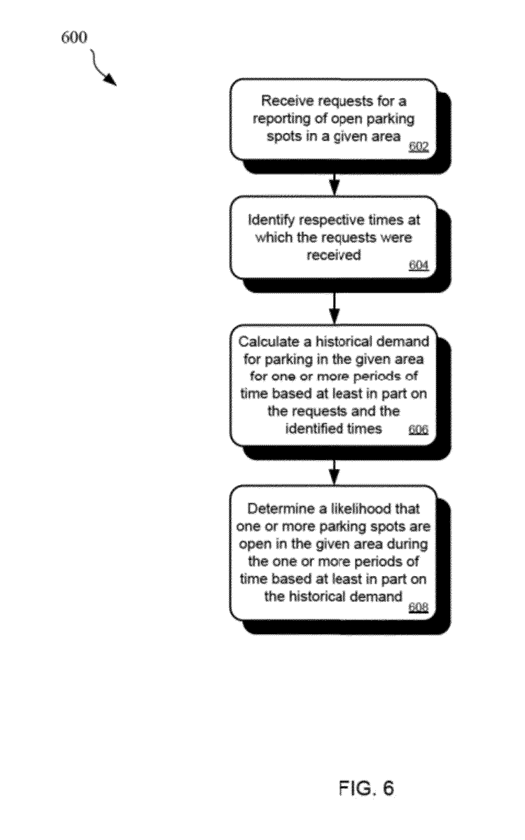

FIG. 6 illustrates a process 600 for determining the availability of one or more parking spots. Requests are received for a reporting of open parking spots in a given area (602). For example, the parking server 304 may receive a plurality of requests from mobile computing devices running a parking tracking application for the identification of one or more open parking spots in the vicinity of the mobile computing devices. The requests may include a number of user preferences that relate to a desired price, time limit, size, and/or location of parking spaces. The requests may also include a time stamp that identifies when the request was generated and/or transmitted.

Respective times at which the requests were received are identified (604). For example, the parking server 304 may identify the times at which the requests were received using time stamps associated with the requests. The time stamps could be applied to the requests by the respective mobile devices that generated the requests, or could be applied by the parking server 304 upon receipt of the requests.

A historical demand is calculated for parking in the given area for one or more periods of time based at least in part on the requests and the identified times (606). In some examples, the parking server 304 uses information associated with the quantity and timing of the received requests in order to infer the demand for parking spots in the given area associated with the requests. For example, if the parking server 304 has received a large number of requests for open parking spots at 7:00 PM every Saturday night for the past six months in a given location (e.g., at a location near a busy restaurant in a large city), the parking server 304 may determine that the demand for parking in that area at 7:00 PM on future Saturday nights will relatively high (e.g., as compared with other time periods and/or locations).

A likelihood is determined that one or more parking spots are open in the given area during the one or more periods of time based at least in part on the historical demand (608). For example, the parking server 304 can use the historical demand data discussed above to infer whether open parking spots exist at a particular time and location. Using the example above, if the parking server 304 has determined that the demand for parking spots at 7:00 PM near a popular restaurant is relatively high, the parking server 304 can determine that parking spots are relatively unlikely to be available in that location at that time. The determination of likelihood can be calculated and stored automatically for predefined ranges of times and locations. The determination of likelihood can also be performed in response to receiving a request for the reporting of open parking spaces from an interested user. In other words, a likelihood of a user generally finding a parking spot in a given area may be computed and reported, or the likelihood of a particular spot still being open may be computed and reported—both using the historical data, so as to show a likelihood of finding parking in an area or at a particular location, respectively.

The historical data may also be used to find parking in a certain area and expected price or range of prices. For example, refill rates and parking spot turnover rates may be used in a model to identify how long a driver will need to seek a spot in an area before finding one. In such instances, a user may identify whether they are willing to park in flat lots, on-street, in ramps, or in any combination of parking area types. The range of prices may be computed by obtaining historical parking spending data for an area. For example, users may use text message payment techniques or near-field communication (NFC) to identify themselves and their financial account information to a parking ramp kiosk or parking meter. The device with which they may be programmed to in turn report to a central system what the parking cost was. The central system may then aggregate such information with indicators of the location of each transaction and the time of the transaction (in and out) in order to build a model that represents the cost of parking in certain areas at certain times. For example, the system may determine that a particular parking ramp charges a fixed all-day amount on weekends, but on weekdays charges a changing hourly rate up to 5 hours.

In some examples, the likelihood of parking being available can be graphically represented to users. For example, the parking server 304 could provide information to a parking application that can be used to generate a color-coded map, where regions of the map are colored based on the likelihood of parking being available at a selected (or current) time. Using the previous example, if the selected or current time is 7:00 PM on a Saturday, a map could be generated in which a geographic region surrounding the popular restaurant is colored in red to represent the low likelihood of parking availability.

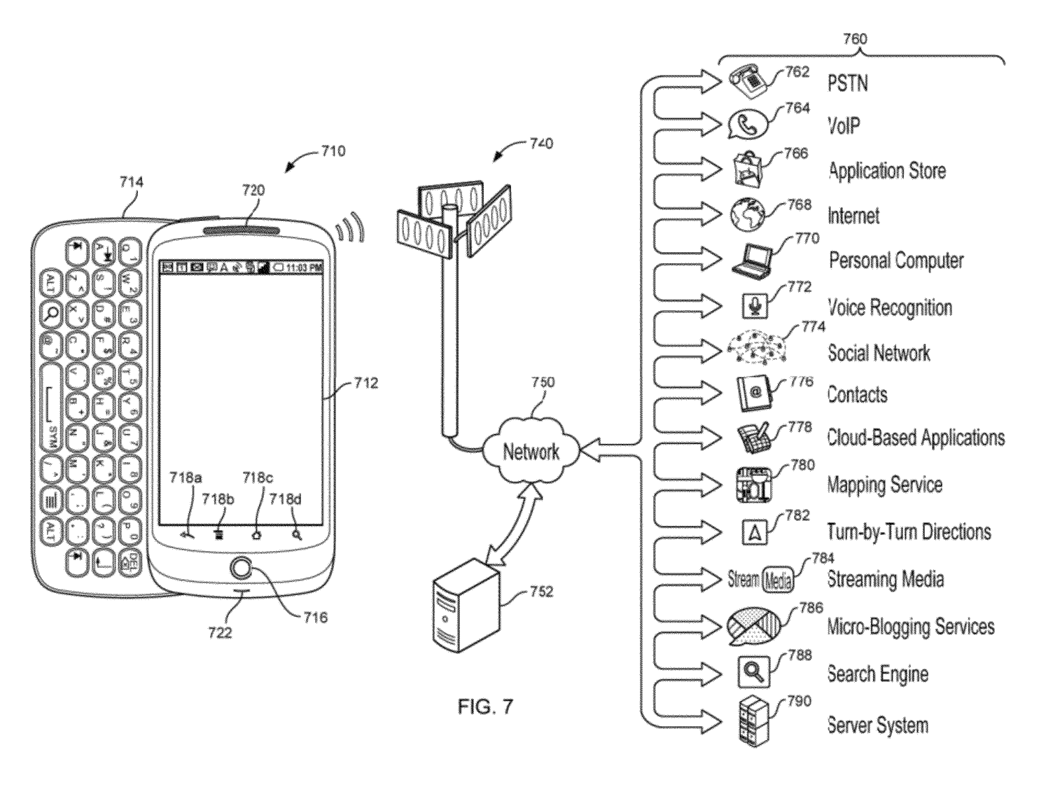

Referring now to FIG. 7, a conceptual diagram of a system that may be used to implement the systems and methods described in this document is illustrated. In the system, mobile computing device 710 can wirelessly communicate with base station 740, which can provide the mobile computing device wireless access to numerous hosted services 760 through a network 750.

In this illustration, the mobile computing device 710 is depicted as a handheld mobile telephone (e.g., a smartphone, or application telephone) that includes a touchscreen display device 712 for presenting content to a user of the mobile computing device 710 and receiving touch-based user inputs. Other visual, auditory, and tactile output components may also be provided (e.g., LED lights, a speaker for providing tonal, voice-generated, or recorded output, or vibrating mechanisms for tactile output), as may various different input components (e.g., keyboard 714, physical buttons, trackballs, accelerometers, gyroscopes, and magnetometers).

Example visual output mechanism in the form of display device 712 may take the form of a 3.7 or 4.3 inch LED or AMOLED display with resistive or capacitive touch capabilities, for displaying video, graphics, images, and text, and coordinating user touch inputs locationally with the displayed information so that user contact above a displayed item may be associated with the item by the device 710. The mobile computing device 710 may take alternative forms also, including as a laptop computer, a tablet or slate computer, a personal digital assistant, an embedded system (e.g., a car navigation system), a desktop personal computer, or a computerized workstation.

An example mechanism for receiving user-input includes keyboard 714, which may be a full qwerty keyboard or a traditional keypad that includes keys for the digits ‘0-9’, ‘*’, and ‘#.’ The keyboard 714 receives input when a user physically contacts or depresses a keyboard key. User manipulation of a trackball 716 or interaction with a trackpad enables the user to supply directional and rate of rotation information to the mobile computing device 710 (e.g., to manipulate a position of a cursor on the display device 712).

The mobile computing device 710 may be able to determine a position of physical contact with the touchscreen display device 712 (e.g., a position of contact by a finger or a stylus). Using the touchscreen 712, various “virtual” input mechanisms may be produced, where a user interacts with a graphical user interface element depicted on the touchscreen 712 by contacting the graphical user interface element. An example of a “virtual” input mechanism is a “software keyboard,” where a keyboard is displayed on the touchscreen and a user selects keys by pressing a region of the touchscreen 712 that corresponds to each key.

The mobile computing device 710 may include mechanical or touch sensitive buttons 718a-d. Additionally, the mobile computing device may include buttons for adjusting volume output by the one or more speakers 720, and a button for turning the mobile computing device on or off. A microphone 722 allows the mobile computing device 710 to convert audible sounds into an electrical signal that may be digitally encoded and stored in computer-readable memory, or transmitted to another computing device. The mobile computing device 710 may also include a digital compass, an accelerometer, proximity sensors, and ambient light sensors.

An operating system may provide an interface between the mobile computing device's hardware (e.g., the input/output mechanisms and a processor executing instructions retrieved from computer-readable medium) and software. Example operating systems include the ANDROID mobile device platform; APPLE IPHONE/MAC OS X operating systems; MICROSOFT WINDOWS 7/WINDOWS MOBILE operating systems; SYMBIAN operating system; RIM BLACKBERRY operating system; PALM WEB operating system; a variety of UNIX-flavored operating systems; or a proprietary operating system for computerized devices. The operating system may provide a platform for the execution of application programs that facilitate interaction between the computing device and a user.

The mobile computing device 710 may present a graphical user interface with the touchscreen 712. A graphical user interface is a collection of one or more graphical interface elements and may be static (e.g., the display appears to remain the same over a period of time), or may be dynamic (e.g., the graphical user interface includes graphical interface elements that animate without user input).

A graphical interface element may be text, lines, shapes, images, or combinations thereof. For example, a graphical interface element may be an icon that is displayed on the desktop and the icon's associated text. In some examples, a graphical interface element is selectable with user-input. For example, a user may select a graphical interface element by pressing a region of the touchscreen that corresponds to a display of the graphical interface element. In some examples, the user may manipulate a trackball to highlight a single graphical interface element as having focus. User-selection of a graphical interface element may invoke a pre-defined action by the mobile computing device. In some examples, selectable graphical interface elements further or alternatively correspond to a button on the keyboard 704. User-selection of the button may invoke the pre-defined action.

In some examples, the operating system provides a “desktop” user interface that is displayed upon turning on the mobile computing device 710, activating the mobile computing device 710 from a sleep state, upon “unlocking” the mobile computing device 710, or upon receiving user-selection of the “home” button 718c. The desktop graphical interface may display several icons that, when selected with user-input, invoke corresponding application programs. An invoked application program may present a graphical interface that replaces the desktop graphical interface until the application program terminates or is hidden from view.

User-input may manipulate a sequence of mobile computing device 710 operations. For example, a single-action user input (e.g., a single tap of the touchscreen, swipe across the touchscreen, contact with a button, or combination of these at a same time) may invoke an operation that changes a display of the user interface. Without the user-input, the user interface may not have changed at a particular time. For example, a multi-touch user input with the touchscreen 712 may invoke a mapping application to “zoom-in” on a location, even though the mapping application may have by default zoomed-in after several seconds.

The desktop graphical interface can also display “widgets.” A widget is one or more graphical interface elements that are associated with an application program that has been executed, and that display on the desktop content controlled by the executing application program. A widget's application program may start with the mobile telephone. Further, a widget may not take focus of the full display. Instead, a widget may only “own” a small portion of the desktop, displaying content and receiving touchscreen user-input within the portion of the desktop.

The mobile computing device 710 may include one or more location-identification mechanisms. A location-identification mechanism may include a collection of hardware and software that provides the operating system and application programs an estimate of the mobile telephone's geographical position. A location-identification mechanism may employ satellite-based positioning techniques, base station transmitting antenna identification, multiple base station triangulation, internet access point IP location determinations, inferential identification of a user's position based on search engine queries, and user-supplied identification of location (e.g., by “checking in” to a location).

The mobile computing device 710 may include other application modules and hardware. A call handling unit may receive an indication of an incoming telephone call and provide a user capabilities to answer the incoming telephone call. A media player may allow a user to listen to music or play movies that are stored in local memory of the mobile computing device 710. The mobile telephone 710 may include a digital camera sensor, and corresponding image and video capture and editing software. An internet browser may enable the user to view content from a web page by typing in an addresses corresponding to the web page or selecting a link to the web page.

The mobile computing device 710 may include an antenna to wirelessly communicate information with the base station 740. The base station 740 may be one of many base stations in a collection of base stations (e.g., a mobile telephone cellular network) that enables the mobile computing device 710 to maintain communication with a network 750 as the mobile computing device is geographically moved. The computing device 710 may alternatively or additionally communicate with the network 750 through a Wi-Fi router or a wired connection (e.g., Ethernet, USB, or FIREWIRE). The computing device 710 may also wirelessly communicate with other computing devices using BLUETOOTH protocols, or may employ an ad-hoc wireless network.

A service provider that operates the network of base stations may connect the mobile computing device 710 to the network 750 to enable communication between the mobile computing device 710 and other computerized devices that provide services 760. Although the services 760 may be provided over different networks (e.g., the service provider's internal network, the Public Switched Telephone Network, and the Internet), network 750 is illustrated as a single network. The service provider may operate a server system 752 that routes information packets and voice data between the mobile computing device 710 and computing devices associated with the services 760.

The network 750 may connect the mobile computing device 710 to the Public Switched Telephone Network (PSTN) 762 in order to establish voice or fax communication between the mobile computing device 710 and another computing device. For example, the service provider server system 752 may receive an indication from the PSTN 762 of an incoming call for the mobile computing device 710. Conversely, the mobile computing device 710 may send a communication to the service provider server system 752 initiating a telephone call with a telephone number that is associated with a device accessible through the PSTN 762.

The network 750 may connect the mobile computing device 710 with a Voice over Internet Protocol (VoIP) service 764 that routes voice communications over an IP network, as opposed to the PSTN. For example, a user of the mobile computing device 710 may invoke a VoIP application and initiate a call using the program. The service provider server system 752 may forward voice data from the call to a VoIP service, which may route the call over the internet to a corresponding computing device, potentially using the PSTN for a final leg of the connection.

An application store 766 may provide a user of the mobile computing device 710 the ability to browse a list of remotely stored application programs that the user may download over the network 750 and install on the mobile computing device 710. The application store 766 may serve as a repository of applications developed by third-party application developers. An application program that is installed on the mobile computing device 710 may be able to communicate over the network 750 with server systems that are designated for the application program. For example, a VoIP application program may be downloaded from the Application Store 766, enabling the user to communicate with the VoIP service 764.

The mobile computing device 710 may access content on the Internet 768 through network 750. For example, a user of the mobile computing device 710 may invoke a web browser application that requests data from remote computing devices that are accessible at designated universal resource locations. In various examples, some of the services 760 are accessible over the internet

The mobile computing device may communicate with a personal computer 770. For example, the personal computer 770 may be the home computer for a user of the mobile computing device 710. Thus, the user may be able to stream media from his personal computer 770. The user may also view the file structure of his personal computer 770, and transmit selected documents between the computerized devices.

A voice recognition service 772 may receive voice communication data recorded with the mobile computing device's microphone 722, and translate the voice communication into corresponding textual data. In some examples, the translated text is provided to a search engine as a web query, and responsive search engine search results are transmitted to the mobile computing device 710.

The mobile computing device 710 may communicate with a social network 774. The social network may include numerous members, some of which have agreed to be related as acquaintances. Application programs on the mobile computing device 710 may access the social network 774 to retrieve information based on the acquaintances of the user of the mobile computing device. For example, an “address book” application program may retrieve telephone numbers for the user's acquaintances. In various examples, content may be delivered to the mobile computing device 710 based on social network distances from the user to other members. For example, advertisement and news article content may be selected for the user based on a level of interaction with such content by members that are “close” to the user (e.g., members that are “friends” or “friends of friends”).

The mobile computing device 710 may access a personal set of contacts 776 through network 750. Each contact may identify an individual and include information about that individual (e.g., a phone number, an email address, and a birthday). Because the set of contacts is hosted remotely to the mobile computing device 710, the user may access and maintain the contacts 776 across several devices as a common set of contacts.

The mobile computing device 710 may access cloud-based application programs 778. Cloud-computing provides application programs (e.g., a word processor or an email program) that are hosted remotely from the mobile computing device 710, and may be accessed by the device 710 using a web browser or a dedicated program. Example cloud-based application programs include GOOGLE DOCS word processor and spreadsheet service, GOOGLE GMAIL webmail service, and PICASA picture manager.

Mapping service 780 can provide the mobile computing device 710 with street maps, route planning information, and satellite images. An example mapping service is GOOGLE MAPS. The mapping service 780 may also receive queries and return location-specific results. For example, the mobile computing device 710 may send an estimated location of the mobile computing device and a user-entered query for “pizza places” to the mapping service 780. The mapping service 780 may return a street map with “markers” superimposed on the map that identify geographical locations of nearby “pizza places.”

Turn-by-turn service 782 may provide the mobile computing device 710 with turn-by-turn directions to a user-supplied destination. For example, the turn-by-turn service 782 may stream to device 710 a street-level view of an estimated location of the device, along with data for providing audio commands and superimposing arrows that direct a user of the device 710 to the destination.

Various forms of streaming media 784 may be requested by the mobile computing device 710. For example, computing device 710 may request a stream for a pre-recorded video file, a live television program, or a live radio program. Example services that provide streaming media include YOUTUBE and PANDORA.

A micro-blogging service 786 may receive from the mobile computing device 710 a user-input post that does not identify recipients of the post. The micro-blogging service 786 may disseminate the post to other members of the micro-blogging service 786 that agreed to subscribe to the user.

A search engine 788 may receive user-entered textual or verbal queries from the mobile computing device 710, determine a set of internet-accessible documents that are responsive to the query, and provide to the device 710 information to display a list of search results for the responsive documents. In examples where a verbal query is received, the voice recognition service 772 may translate the received audio into a textual query that is sent to the search engine.

These and other services may be implemented in a server system 790. A server system may be a combination of hardware and software that provides a service or a set of services. For example, a set of physically separate and networked computerized devices may operate together as a logical server system unit to handle the operations necessary to offer a service to hundreds of individual computing devices.

In various implementations, operations that are performed “in response” to another operation (e.g., a determination or an identification) are not performed if the prior operation is unsuccessful (e.g., if the determination was not performed). Features in this document that are described with conditional language may describe implementations that are optional. In some examples, “transmitting” from a first device to a second device includes the first device placing data into a network for receipt by the second device, but may not include the second device receiving the data. Conversely, “receiving” from a first device may include receiving the data from a network, but may not include the first device transmitting the data.

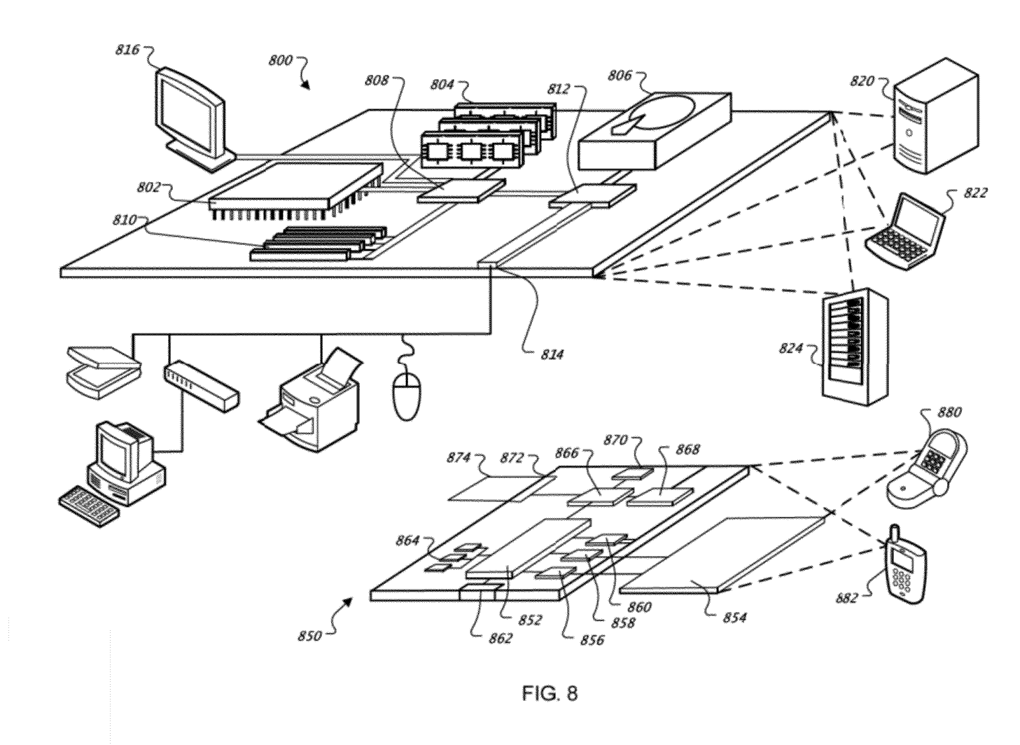

FIG. 8 is a block diagram of computing devices 800, 850 that may be used to implement the systems and methods described in this document, as either a client or as a server or plurality of servers. Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smartphones, and other similar computing devices. The components shown here, their connections and relationships, and their functions, are meant to be exemplary only, and are not meant to limit implementations described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk. Additionally computing device 800 or 850 can include Universal Serial Bus (USB) flash drives. The USB flash drives may store operating systems and other applications. The USB flash drives can include input/output components, such as a wireless transmitter or USB connector that may be inserted into a USB port of another computing device.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, or memory on processor 802.

The high speed controller 808 manages bandwidth-intensive operations for the computing device 800, while the low speed controller 812 manages lower bandwidth-intensive operations. Such allocation of functions is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT (Thin-Film-Transistor Liquid Crystal Display) display or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provide in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provide as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852 that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, WiFi, or other such transceiver (not shown). In addition, GPS (Global Positioning System) receiver module 870 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smartphone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for performing the systems and methods described in this document may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

1-22. (canceled)

23. A computer-implemented method for tracking parking spot availability, the method comprising:
receiving, at a computer server system, a report of a first parking spot being open and parking data that indicates a geographic location of the first parking spot, the report being generated based at least in part on determining with sensors on a first computing device that the first computing device has left the first parking spot;
receiving, at the computer server system and from a second computing device, a request to receive reports of open parking spots;
determining a state of the first parking spot based at least in part on an amount of time that has elapsed since the report of the first parking spot being open was received;
selecting, using the determined state, a graphical indication that indicates a likelihood that the first parking spot is open, from a plurality of graphical indications that each represent different likelihoods, other than zero likelihood, that an identified parking spot is open; and
providing in response to the received request, data for generating the selected graphical indication on a map of an area around the first parking spot for presentation by the second computing device, the graphical indication indicating the location of the parking spot and indicating the likelihood that the parking spot is open.

24. The computer-implemented method of claim 23, wherein determining the state of the first parking spot includes determining whether the first parking spot is a public parking spot.

25. The computer-implemented method of claim 23, wherein the likelihood that the first parking space is open is based on a time since the first parking spot was reported by the first computing device and historical information gathered by the computer server system that indicates historical demand for parking spots in an area around the open parking spot.

26. The computer-implemented method of claim 23, wherein the graphical indication, when presented, indicates a number of minutes that have elapsed since the report of the first parking spot being open was received.

27. The computer-implemented method of claim 26, wherein the graphical indication, when presented, comprises a timer face and a timer hand, wherein the position of the timer hand relative to the timer face is proportional to an amount of time that has elapsed since the report of the first parking spot being open was received.

28. The computer-implemented method of claim 23, further comprising receiving, at the computer server system, reports of a plurality of parking spots being open and parking data that indicates geographic locations of respective ones of the plurality of parking spots;
identifying parking spots of the plurality of parking spots that are near a device that provided the request to receive reports;
determining states of respective ones of the identified parking spots;
selecting, using the determined states, graphical indications for each of the identified parking spots, that visually indicate a likelihood that particular ones of the identified parking spots are open, from a plurality of graphical indications that each represent different likelihoods, other than zero likelihood; and
providing in response to the received request, data for generating the selected graphical indications on a map of an area around the open parking spot for presentation by the second computing device, the graphical indications indicating respective locations of the identified parking spots and indicating the likelihood that the parking spots are open.

29. The computer-implemented method of claim 23, wherein the likelihood is compared to three or more thresholds, each threshold representative of a different likelihood, along a range of likelihoods, that the first parking spot is still open.

30. The computer-implemented method of claim 29, wherein the graphical indication comprises three or more visually distinguishable graphical representations that each correspond to a different one of the thresholds.

31. The computer-implemented method of claim 23, further comprising providing, to the second computing device, turn-by-turn navigation directions from a current location of the second computing device to the first parking spot.

32. A computer-implemented system for tracking parking spot availability, the system comprising:
an interface of a computer system arranged to receive from mobile computing devices reports that indicate geographic locations of open parking spots at current locations of the mobile devices;
one or more timers, implemented by the computer system, for determining elapsed times relative to reports of open parking spots reported by the mobile devices;
an open spot identifier programmed to respond to requests from computing devices to identify open spots in particular geographic areas, the open spot identifier using the reports and the elapsed times to identify spots likely to be open and geographic locations of the spots likely to be open, and to select identifiers that represent likelihoods that particular ones of the parking spots are open, the identifiers selected from a plurality of identifiers that each represent a likelihood, other than zero, that a parking spot is open; and
an interface of the computer system programmed to provide, to the requesting mobile devices, data formatted for display on maps of geographic areas that correspond to identified spots likely to be open and states of identified spots.

33. The system of claim 32, wherein the one or more timers are programmed to identify differences between times associated with the reports from the mobile computing devices, and times associated with the requests to identify open spots.

34. The system of claim 33, further comprising an historical demand calculator programmed to identify a historical demand over defined time periods for parking in particular areas for one or more periods of time based at least in part on requests received by mobile devices and times at which the requests were received, and to provide information about the historical demand to the open spot identifier.

35. The system of claim 34, wherein the open spot identifier is programmed to determine a likelihood that one or more parking spots are open in the given area during one or more periods of time based at least in part on the historical demand.

36. The system of claim 32, wherein the likelihood that a spot is open is compared to three or more thresholds, each threshold representative of a different likelihood that the spot is open.

37. A computer-implemented method for tracking parking spot availability, the method comprising:
providing, from a first computing device to a computer system that is remote from the first computing device, a request to receive information about open parking spots in a geographic area;
receiving in response from the computer system data that indicates locations and states of likely open parking spots, the states having been determined by elapsed time since spots were reported by other computing devices as being open; and
presenting on the first computing device information that indicates locations and states of the likely open parking spots, the states each being selected from multiple different likelihoods, other than zero, that a particular spot will be open and presented to communicate a selected likelihood for a particular open parking space.

38. The method of claim 37, wherein the states are determined using an identified historical demand over defined time periods for parking in a particular area for one or more periods of time based at least in part on requests received by mobile devices and times at which the requests were received.

39. The method of claim 37, wherein the states each represent one of three or more different likelihoods that likely open parking spots are open.

40. The method of claim 37, wherein presenting the information that represents the states of the likely open parking spots comprises presenting an indication of an amount of time that has elapsed since particular ones of the open parking spots have been reported as being open.

41. The method of claim 39, wherein presenting the information that indicates locations and states comprises displaying a map with icons, at locations of particular open parking spots, selected from three or more visually distinguishable icon types, each icon type corresponding to a different likelihood that a particular spot is open.

42. The method of claim 37, further comprising receiving, from a user of the computing device, input that indicates layers of information the user desires to see on the computing device, and changing content types that are displayed to the user on a map on the computing device in response, wherein icons displaying locations of open parking spots are on one of the layers.

43. One or more computer-readable storage mediums having stored thereon instructions that when executed perform operations comprising:
providing, from a first computing device to a computer system that is remote from the first computing device, a request to receive information about open parking spots in a geographic area;
receiving in response from the computer system data that indicates locations and states of likely open parking spots, the states having been determined by elapsed time since spots were reported by other computing devices as being open; and
presenting on the first computing device information that indicates locations and states of the likely open parking spots, the states each being selected from multiple different likelihoods, other than zero, that a particular spot will be open and presented to communicate a selected likelihood for a particular open parking space.

44. The one or more computer-readable storage mediums of claim 43, wherein the states each represent one of three or more different likelihoods that the likely open parking spots are open, and wherein the states displayed on the map are displayed using one of three or more visual representations, each visual representation indicating the likelihood that the corresponding likely open parking spot is open.
